(19) United States
(12) Patent Application Publication
(10) Pub. No.: US 2017/0099405 A1
(43) Pub. Date: Apr. 6, 2017

(54) CONTROL APPARATUS AND CONTROL METHOD

(71) Applicant: Hajime TAKAYAMA, Tokyo (JP)

(72) Inventor: Hajime TAKAYAMA, Tokyo (JP)

(21) Appl. No.: 15/265,088

(22) Filed: Sep. 14, 2016

(30) Foreign Application Priority Data
Oct. 2, 2015 (JP) 2015-196842

(51) Int. Cl. H04N 1/00; H04W 52/02

(52) U.S. Cl. CPC H04N 1/00891; H04W 52/0235; H04N 1/00204; H04N 2201/0094

(57) ABSTRACT

A control apparatus mounted on equipment to control the equipment, the control apparatus includes: a plurality of communication control devices capable of communication with external equipment via a single communication connection terminal configured for communication with external equipment; a switch configured to connect the communication connection terminal to any one of the plurality of communication control devices; and a control unit configured to perform control operations including selecting one, the one being suitable for a function enabled on the equipment where the control apparatus is mounted and minimizing power consumption, of the plurality of communication control devices, causing the switch to connect the selected communication control device to the communication connection terminal, and minimizing power consumption of the other, not-selected communication control device.

### CROSS-REFERENCE TO RELATED APPLICATIONS

The present application claims priority under 35 U.S.C. §119 to Japanese Patent Application No. 2015-196842 filed Oct. 2, 2015. The contents of which are incorporated herein by reference in their entirety.

### BACKGROUND OF THE INVENTION

1. Field of the Invention

The present invention relates generally to control apparatuses and control methods.

2. Description of the Related Art

Conventionally, some type of image forming apparatuses is configured to allow a user to add hardware, add a function that is not initially provided, or enable/disable a certain function for convenience of the user. Thus, functions implemented by an image forming apparatus vary depending on hardware structure and settings of the image forming apparatus.

### SUMMARY OF THE INVENTION

According to exemplary embodiments of the present invention, there is provided a control apparatus mounted on equipment to control the equipment, the control apparatus comprising: a plurality of communication control devices capable of communication with external equipment via a single communication connection terminal configured for communication with external equipment; a switch configured to connect the communication connection terminal to any one of the plurality of communication control devices; and a control unit configured to perform control operations including selecting one, the one being suitable for a function enabled on the equipment where the control apparatus is mounted and minimizing power consumption, of the plurality of communication control devices, causing the switch to connect the selected communication control device to the communication connection terminal, and minimizing power consumption of the other, not-selected communication control device.

Exemplary embodiments of the present invention also provide a control apparatus mounted on equipment to control the equipment, the control apparatus comprising: a plurality of communication control devices capable of communication via any one of a plurality of communication connection terminals configured for communication with external equipment; a switch configured to connect each of the plurality of communication connection terminals to any one of the plurality of communication control devices; and a control unit configured to perform control operations including selecting one, the one being suitable for a function enabled on the equipment where the control apparatus is mounted and minimizing power consumption, of the plurality of communication control devices, causing the switch to connect the selected communication control device to the communication connection terminal, and minimizing power consumption of the other, not-selected communication control device.

Exemplary embodiments of the present invention also provide a control method for a control apparatus mounted on equipment to control the equipment, the control method comprising the following control operations performed by a control unit included in the control apparatus: selecting one, the one being suitable for a function enabled on the equipment where the control apparatus is mounted and minimizing power consumption, of a plurality of communication control devices capable of communication with external equipment via a single communication connection terminal configured for communication with external equipment; causing a switch, the switch being configured to connect the communication connection terminal to any one of the plurality of communication control devices, to connect the selected communication control device to the communication connection terminal; and minimizing power consumption of the other, not-selected communication control device.

### BRIEF DESCRIPTION OF THE DRAWINGS

FIG. 1 is a block diagram illustrating a configuration of a control apparatus according to a first embodiment of the present invention;

FIG. 2A is an explanatory diagram of endpoints inside a USB device controller (USB-CTL(A)) of the first embodiment;

FIG. 2B is an explanatory diagram of endpoints inside a USB device controller (USB-CTL(B)) of the first embodiment;

FIG. 3 is a diagram illustrating the control apparatus, where the USB device controller on an SoC is selected, of the first embodiment;

FIG. 4 is a diagram illustrating the control apparatus, where the USB device controller on an ASIC is selected, of the first embodiment;

FIG. 5 is a flowchart illustrating how a CPU of the control apparatus of the first embodiment operates at startup;

FIG. 6 is a flowchart illustrating how the CPU of the control apparatus of a second embodiment of the present invention operates at startup;

FIG. 7 is a block diagram illustrating a configuration of the control apparatus including an operating unit of the second embodiment;

FIG. 8 is a diagram illustrating an example operational screen on the operating unit included in the control apparatus of the second embodiment;

FIG. 9 is a block diagram illustrating a configuration of the control apparatus including a communication I/F for connection with an external network of the second embodiment;

FIG. 10 is a diagram illustrating an example operational screen on an external apparatus, from which the control apparatus including the communication I/F for connection with the external network of the second embodiment is operated over the network;

FIG. 11 is a flowchart of operations performed by the control apparatus of the second embodiment when data (a setting value) stored in a rewritable nonvolatile memory is changed;

FIG. 12 is an explanatory diagram of a configuration for detecting whether or not a physical USE connector is mounted of a third embodiment of the present invention; and

FIG. 13 is a block diagram illustrating a configuration of a control apparatus of the third embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Exemplary embodiments of the present invention are described in detail below with reference to the accompanying drawings.

### (Overview)

According to the embodiments described below, a control apparatus includes a plurality of communication control devices for communication with external equipment. The control apparatus of the embodiments is configured to select one, that meets requirements for communication between equipment controlled by the control apparatus and external equipment (e.g., a PC (personal computer)) and that minimizes power consumption, of the plurality of communication control devices and connect the communication control device to the external equipment. In particular, the control apparatus of the embodiments reduces power consumption when a function(s) of an image forming apparatus, such as an MFP (multifunction peripheral) and a printer, is controlled by external equipment via a USB (Universal Serial Bus) interface. Specifically, when the control apparatus is used to implement functions, including a printer function and a scanner function of an MFP and a printer function of a printer, of a plurality of types of image forming apparatuses in a manner that the control apparatus is shared thereamong, the control apparatus eliminates waste of power consumed in communication with the external equipment, thereby achieving reduction in power consumption.

Logical transfer pipes and endpoints are defined in the USB standard. Transfer pipes to be implemented for respective functions are also defined in the USB standard as “Class Definition”. For example, to operate a printer function, the following are required to conform to the Universal Serial Bus Device Class Definition for Printing Devices.
Control Transfer pipe (for basic communication defined in the USB standard; usable in a manner shared among the printer function and another/other function(s))
Bulk-OUT Transfer pipe (for use in transmitting image data from the PC to the MFP, for example)
Bulk-IN Transfer pipe (for use in, for example, communication from the MFP to the PC for announcing a remaining amount of toner, for example)

Although the scanner function is not specifically defined as a USB device class in the USB standard, the following are required.
Control Transfer pipe (for basic communication defined in the USB standard; usable in a manner shared among the scanner function and another/other function(s))
Bulk-OUT transfer pipe (for use in transmitting scanner control from the PC to the MFP, for example)
Bulk-IN Transfer pipe (for use in transmitting scan data from the MFP to the PC, for example)

From the above, the following transfer pipes are required to enable an MFP that utilizes USB in communication with an external entity to implement both the printer function and the scanner function.
One Control Transfer pipe (for shared use by the printer function and the scanner function)
Two Bulk-OUT Transfer pipes (one for the printer function and the other for the scanner function)
Two Bulk-IN Transfer pipes (one for the printer function and the other for the scanner function)

In consideration of the USB standard, to implement these transfer pipes, it is desirable that the communication control device controls the necessary number of (in the above-described example, five) transfer pipes. For example, to implement an MFP supporting the printer function and the scanner function, an LSI (large scale integrated circuit) or an ASIC for communication control supporting the necessary number of (five) transfer pipes may be used.

However, increasing the number of transfer pipes using a general LSI or an ASIC implementing a communication control device undesirably increases the size of circuits including FIFO (first-in, first-out) buffers serving as corresponding endpoints. Meanwhile, for equipment, such as an MFP and a printer, whose standby time with power on is long, power consumption of the equipment during standby exerts large influence on total power consumption even if the power consumption during standby is small.

Specifically, increasing the number of transfer pipes or, in other words, increasing the size of corresponding circuit, of equipment where importance is placed on power-saving capability during standby disadvantageously leads to an increase in standby power consumption.

To alleviate this disadvantage, the control apparatus of the embodiments described below is configured to select, for each piece of equipment where the control apparatus is applied, one that has a minimum required number of endpoints (i.e., does not consume power wastefully) of a plurality of communication control devices and place the other communication control device in its minimum-power-consumption state, thereby achieving shared use of the control apparatus and reduction in power consumption.

### First Embodiment

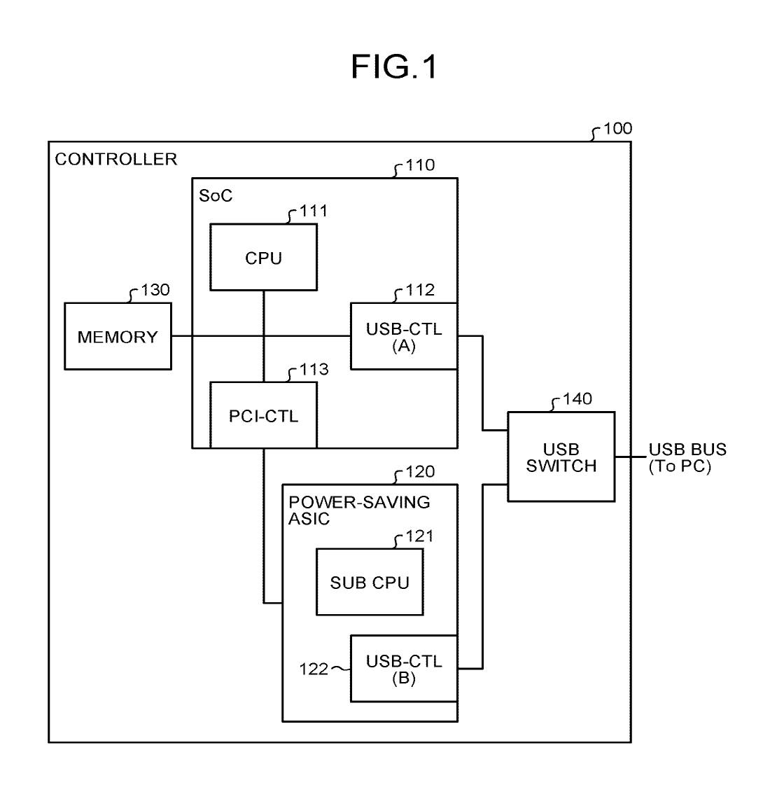

FIG. 1 is a block diagram illustrating a configuration of a control apparatus according to a first embodiment of the present invention. An example configuration where USB device controllers, which are the communication control devices, are used is described below.

A controller 100, which is the control apparatus, illustrated in FIG. 1 includes an SoC 110 for normal operation, an ASIC 120 for power saving operation (indicated as “POWER-SAVING ASIC” in FIG. 1), a memory 130, and a USB switch (bus switch) 140. An SoC, an abbreviation for System On Chip, is a circuit where a CPU and peripheral interfaces are integrated. In the example illustrated in FIG. 1, a CPU (central processing unit) 111 (control unit), a USB device controller (indicated as “USB-CTL(A)” in FIG. 1) 112, and a PCI (peripheral component interconnect) controller (indicated as “PCI-CTL” in FIG. 1) 113 are integrated into the SoC 110. An ASIC, an abbreviation for application specific integrated circuit, is an integrated circuit where circuits for a plurality of functions are integrated into a single circuit for a specific purpose. In the example illustrated in FIG. 1, a sub CPU 121 and a USB device controller (indicated as “USB-CTL(B)” in FIG. 1) 122 are integrated into the power-saving ASIC 120. The SoC 110 and the ASIC 120 are connected via the PCI controller 113. Each of the SoC 110 and the ASIC 120 may include another device(s).

The memory 130 includes a nonvolatile storage device (such as a ROM (read only memory) and an EEPROM (electrically erasable programmable read-only memory)) where initial instructions for the CPU 111 on the SoC 110, other control instructions, setting values, and the like are stored, and a RAM (random access memory), which is a main storage device, and is connected to the SoC 110.

The USB switch 140 is a device that switches input/output (signal line) to a USB bus coupled to an external apparatus, such as a PC, between the plurality of (in FIG. 1, two) USB device controllers 112 and 122. The USB switch 140 connects any one of the USB device controllers 112 and 122 to the USB bus. Switching using the USB switch 140 is performed under control of the CPU 111 on the SoC 110 at startup (or at restart) of equipment.

In the first embodiment, it is assumed that the USB device controller 112 includes five transfer pipes; the USE device controller 122 includes three transfer pipes. For simplicity of description, description is made on an assumption that the controller 100 includes the USB device controllers 112 and 122 as two communication control devices and switches therebetween. However, the number of the communication control devices may be any number larger than one. For example, the controller 100 may further include a third USB device controller including seven transfer pipes on another ASIC or the like. In this case, the USB switch 140 may preferably perform switching among the three USB device controllers.

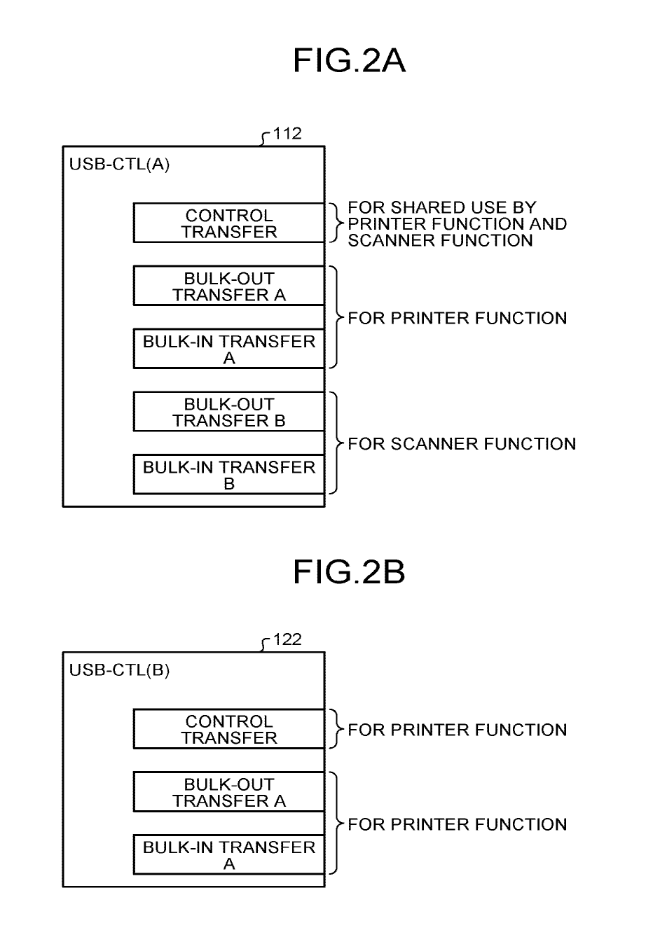

FIG. 2A and FIG. 2B are explanatory diagrams of endpoints inside the USB device controller 112 and endpoints inside the USB device controller 122, respectively, of the first embodiment. Each of the USB device controllers 112 and 122 is similar to a conventional USB device controller configured in accordance with the USB standard, and detailed description of their configuration is omitted.

The USB device controller 112 illustrated in FIG. 2A includes one endpoint corresponding to a Control Transfer pipe, two endpoints corresponding to Bulk-OUT Transfer pipes, and two endpoints corresponding to Bulk-IN Transfer pipes. This configuration allows an MFP to provide both a function for printing via USB (printer function) and a function for scanning via USB (scanner function). The USB device controller 122 illustrated in FIG. 2B includes one endpoint corresponding to a Control Transfer pipe, one endpoint corresponding to a Bulk-OUT Transfer pipe, and one endpoint corresponding to a Bulk-IN Transfer pipe. This configuration allows providing only either the function for printing via USB or the function for scanning via USB.

Comparison between the USB device controllers 112 and 122 reveals that the USB device controller 112 has two more endpoints corresponding to transfer pipes than the USB device controller 122 and therefore has a larger circuit size. Therefore, if the USB device controllers 112 and 122 are identical in configuration other than the endpoints, operating power consumption of the USB device controller 112 is larger than that of the USB device controller 122.

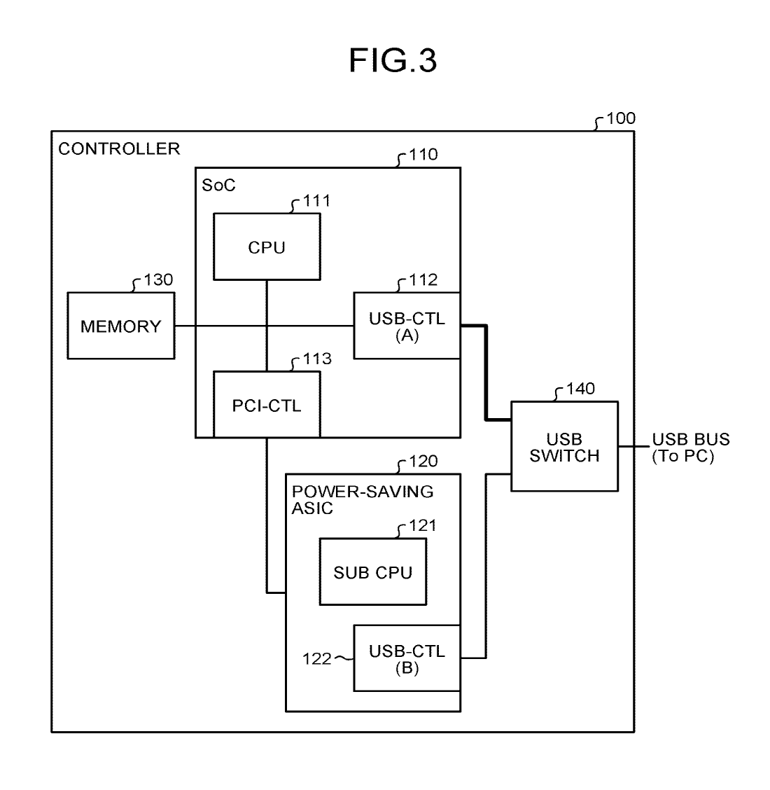

FIG. 3 is a diagram illustrating a state where the USB device controller 112 on the SoC 110 is selected.

As described above, the USB device controller 112 includes the five transfer pipes and can provide the printer function via USB and the scanner function via USB simultaneously, for example. When the controller 100 is mounted on an MFP having the printer function and the scanner function to control the MFP, a signal line coupled to a communication connection terminal (USB connector) for connection with external equipment is connected to the USB device controller 112 (indicated by the thick line in FIG. 3) by the USB switch 140, so that both the printer function via USB and the scanner function via USB are provided to the external equipment. At this time, the not-selected USB device controller 122 is set to its minimum power consumption state. Accordingly, when the MFP is connected to an external PC via the USB connector of the MFP, the USB device controller 112 performs communication with the PC. Hence, using both the printer function and the scanner function provided by the MFP is allowed to the PC.

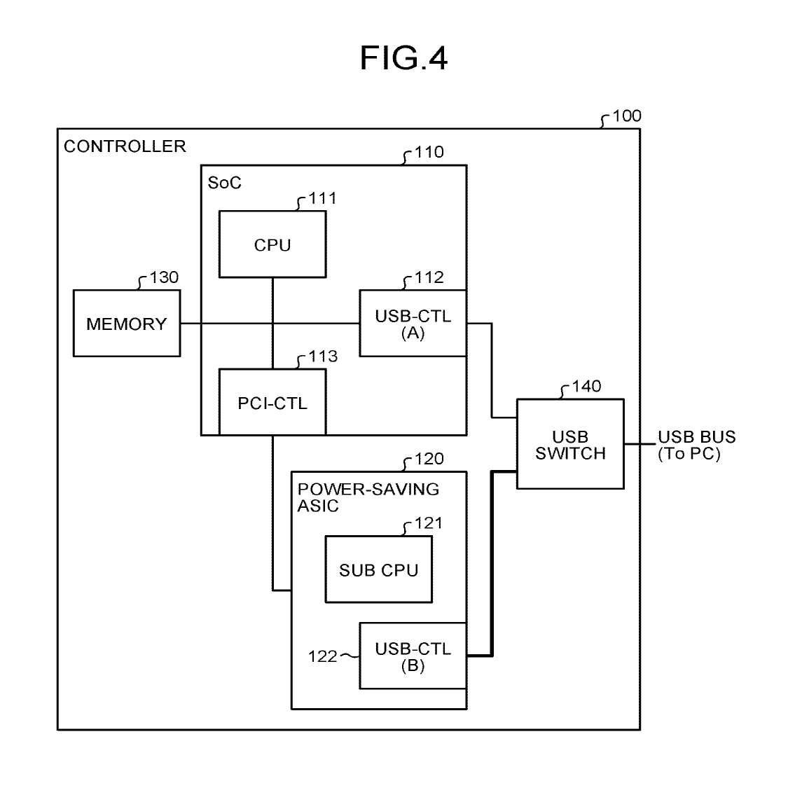

FIG. 4 is a diagram illustrating a state where the USB device controller 122 on the ASIC 120 is selected.

As described above, the USB device controller 122 includes the three transfer pipes and can provide only either the printer function via USB or the scanner function via USB, for example. When the controller 100 is mounted on a printer to control the printer, the scanner function via USB is unnecessary. Therefore, the signal line coupled to the communication connection terminal (USB connector) for connection with an entity external to the printer is connected to the USB device controller 122 by the USB switch 140, so that the printer provides the printer function via USB. Accordingly, when the printer is connected to a PC via this USB connector, the USB device controller 122 performs communication with the external PC. Hence, using only the printer function is allowed to the PC.

Similarly, when the controller 100 is mounted on a scanner to control the scanner, the printer function via USB is unnecessary. Therefore, as in the above-described case of the printer, the signal line coupled to the communication connection terminal (USB connector) for connection with an entity external to the scanner is connected to the USB device controller 122 by the USB switch 140, so that the scanner provides the scanner function via USB. Accordingly, when the scanner is connected to a PC via this USB connector, the USB device controller 122 performs communication with the PC. Hence, using only the scanner function is allowed to the PC.

As described above, in the state where the USB device controller 122 on the ASIC 120 is selected, the USB device controller 112 on the SoC 110 is not used. Accordingly, in this case, clock supply and power supply to the USB device controller 112 are stopped inside the SoC 110, thereby disabling the USB device controller 122. As a result, the USB device controller 112 is set to its minimum power consumption state.

It is possible to power off not only the USB device controller 112 but also the entire SoC 110 by employing a configuration that causes the SoC 110 to restart in response to a wake signal for wake up from a power-saving state. This configuration is employable when the USB device controller 122 can output the wake signal at start of USB communication that involves processing by the SoC 110 or when the wake signal can be supplied to the SoC 110 triggered by another activity (e.g., opening, by a user, a pressure plate of an image forming apparatus controlled by the controller 100, placing an original document on an ADF (automatic document feeder) tray, or operating the operating unit) performed on equipment where the controller 100 is mounted. In this power-saving state, because the SoC 110 is stopped and only the power-saving ASIC 120 is operating, further reduction in power consumption than that achieved by virtue of the difference in the size of the circuit between the USB device controllers 112 and 122 can be obtained.

Hereinafter, with regard to selection between the two USB device controllers (112 and 122), how determination for switching is made to connect the USB bus to one of the USB device controllers 112 and 122 is described below.

Generally, the controller 100 can determine what function the equipment controlled by the controller 100 has by detecting whether or not a functional module (e.g., a scanner module or an image formation engine) for implementing the function is connected to the controller 100. For example, when the controller 100 is connected to equipment where a scanner module is mounted to control the scanner module, the CPU 111 of the controller 100 can determine that the equipment controlled by the controller 100 (hereinafter, “controlled equipment”) has the scanner function. Similarly, the controller 100 can determine whether or not an image formation engine and a FAX module are mounted.

Hence, the controller 100 can be configured to select the USB device controller as follows: when, for example, it is determined that equipment controlled by the controller 100 has a scanner module and an image formation engine, the controller 100 selects the USB device controller 112, but when only either the scanner module or the image formation engine is detected, the controller 100 selects the USB device controller 122. To implement such selection, the controller 100 holds, for each of functional modules that may be included in equipment controlled by the controller 100, the number of transfer pipes (i.e., the number of endpoints) required to operate in the form of data. For example, such a table as TABLE 1 illustrated below (hereinafter, simply referred to as “TABLE 1”) is stored in the nonvolatile storage device of the memory 130.

TABLE 1

| | Function-Specific EP Count | |
|---|---|---|
| Function | BI | BO |
| Printer | 1 | 1 |
| Scanner | 1 | 1 |
| Fax | 1 | 1 |

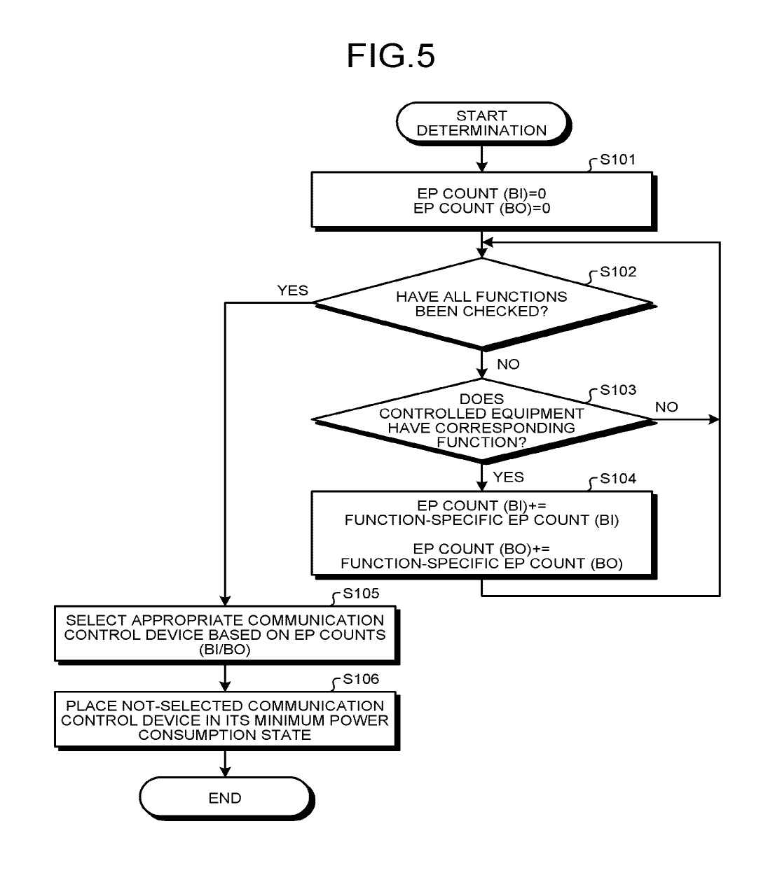

In the first embodiment, at startup of the controlled equipment, the CPU 111 of the controller 100 checks what functional module(s) the equipment has, counts the number of endpoints required by the functional module(s) the equipment has, and selects the USB device controller 112 or 122 that has the necessary number of endpoints. The CPU 111 places the not-selected USB device controller 112 or 122 in its minimum power consumption state. FIG. 5 illustrates how the CPU 111 operates to implement this.

As illustrated in FIG. 5, first, the CPU 111 initializes a variable “EP count (BI)” representing the number of endpoints for Bulk-IN Transfer and a variable “EP count (BO)” representing the number of endpoints for Bulk-OUT Transfer to zero (step S101).

Thereafter, the CPU 111 accesses TABLE 1 illustrated above and determines whether all the functions contained in TABLE 1 have been checked (step S102).

If there is any function that is not checked yet (No at step S102), the CPU 111 checks whether the controlled equipment has one (corresponding function) of the functions presented in TABLE 1 (step S103).

If the controlled equipment has a corresponding function (Yes at S103), the CPU 111 adds a function-specific EP count of the corresponding function presented in TABLE 1 to each of the variable EP count (BI) and the variable EP count (BO) (step S104). Specifically, calculation is performed using the following equations:

EP count (BI)+=function-specific EP count (BI)

EP count (BO)+=function-specific EP count (BO)

where the operator “+=” represents addition assignment.

When the calculation is completed (step S104) or when the controlled equipment has no corresponding function (No at step S103), the CPU 111 returns processing to step S102.

If all the functions presented in TABLE 1 have been checked (Yes at step S102), the CPU 111 selects one of the communication control devices (the USB device controller 112 or 122) having a minimum required number of endpoints or, put another way, minimizing power consumption, based on a result of calculation of the EP count (BI) and the EP count (BO). Specifically, the CPU 111 controls the USB switch 140 so as to connect the signal line to the corresponding communication control device (step S105).

Lastly, the CPU 111 places the not-selected USB device controller 112 or 122 in its minimum power consumption state (step S106).

As described above, in the first embodiment, the controller 100 selects, based on a function(s) to be used in equipment where the controller 100 is mounted, one that has a minimum required number of transfer pipes or, put another way, that is suitable for a function(s) enabled on the equipment where the controller 100 is mounted, and that minimizes power consumption, of the communication control devices and places the other communication control device in its minimum power consumption state. The first embodiment thus achieves reduction in wasteful power consumption in the controller 100 applicable to (i.e., for shared use by) a plurality of types of equipment.

### Second Embodiment

As a second embodiment of the present invention, the controller 100 may be configured to select the USB device controller 112 or 122 in accordance with an operating mode, which is stored in a rewritable nonvolatile storage device included in the memory 130 included in the controller 100, of equipment controlled by the controller 100. The operating mode indicates whether a function(s), of one or more functions provided via USE connection by the image forming apparatus where the controller 100 is mounted, a user desires to use is enabled or disabled. The second embodiment is similar to the first embodiment in hardware structure except the above.

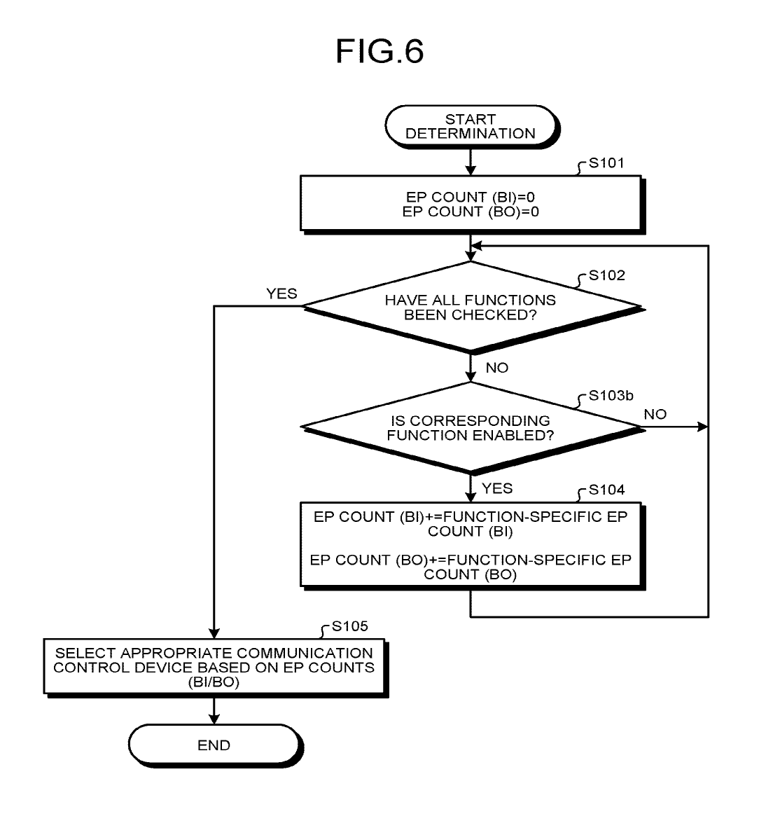

FIG. 6 is a flowchart illustrating how the CPU 111 of the controller 100 of the second embodiment operates at startup. In the second embodiment, determination at S103b of FIG. 6 is made using a criterion “IS CORRESPONDING FUNCTION ENABLED?” in place of the criterion “DOES CONTROLLED EQUIPMENT HAVE CORRESPONDING FUNCTION?” used in determination at step S103 of FIG. 5, and settings as to whether each of the functions is enabled/disabled are stored in the above-described rewritable nonvolatile storage device as operating mode information. For example, there can be a case where only the scanner function via USB is enabled in a copier because, although the copier has a scanner module and an image formation engine, the copier is incapable of accepting a print request from external equipment. In this case, the controller 100 can deem that only the scanner function via USE is enabled in accordance with information contained in such a table as TABLE 2 illustrated below and, as a result, select the USB device controller 122 that consumes less power.

TABLE 2

| | Function-Specific EP | | |
|---|---|---|---|
| | Count | | Operating Mode |
| Function | BI | BO | Information |
| Printer | 1 | 1 | Disabled |
| Scanner | 1 | 1 | Enabled |
| Fax | 1 | 1 | Disabled |

When the printer function via USB is provided by using IPP (Internet Printing Protocol) over USB protocol in transferring print data, four transfer pipes in total (two Bulk-OUT Transfer pipes and two Bulk-IN Transfer pipes) are required in contrast to the above-described USB printing. There is no choice but to select the USB device controller 112 to support the above-described IPP over USB even for equipment, such as a printer, having only an image formation engine. However, even in such a case, an appropriate one of the USB device controllers 112 and 122 can be selected by using the operating mode information stored in the rewritable nonvolatile storage device included in the memory 130. In this case, as illustrated in TABLE 3 below, “Printer with IPP”, “Scanner with IPP”, and “FAX with IPP” are added as “Function” to TABLE 2 described above, and the number of required endpoints (i.e., the number of transfer pipes) is recorded for each of the functions. As the operating mode information, which function(s) is (are) enabled is stored.

TABLE 3

| | Function-Specific EP | | |
|---|---|---|---|
| | Count | | Operating Mode |
| Function | BI | BO | Information |
| Printer | 1 | 1 | Enabled |
| Scanner | 1 | 1 | Disabled |
| Fax | 1 | 1 | Disabled |
| Printer with IPP | 2 | 2 | Enabled |
| Scanner with IPP | 2 | 2 | Disabled |
| Fax with IPP | 2 | 2 | Disabled |

The data stored in the rewritable nonvolatile storage device included in the memory 130 may be set depending on functional specification of the equipment and the like before the equipment is shipped from factory. It is possible to further store a result of the above-described determination in the rewritable nonvolatile storage device, thereby eliminating the need of making determination at every startup. With this configuration, if the stored data representing a determination result is its initial value, the CPU 111 on the SoC 110 makes the above-described determination and stores a result of the determination in the rewritable nonvolatile storage device. On the other hand, if it is not its initial value, the CPU 111 determines that the determination result is already stored and selects one of the USB device controllers 112 and 122 based on the stored value. In a case where a change that may affect a result of the determination is made to the configuration of the equipment, the CPU 111 on the SoC 110 erases the stored determination result and makes the above-described determination at the next startup. As a matter of course, a configuration, in which the CPU 111 on the SoC 110 makes the above-described determination when the result is erased and causes a new result of the determination to be stored rather than initializing the stored determination result, can be employed.

Whether or not a change that may affect the determination result is made to the configuration of the equipment can be determined by the following manner, for example. A list of attributes of software, which are contained in control instructions for implementing the functions, that affects the determination result is stored in the memory 130 in advance. When software contained in the list is rewritten, it is determined that “a change that may affect a result of the determination is made to the configuration of the equipment”. Examples of the change made to the configuration of the equipment include rewriting of software to add the printer function to an MFP having only the copier function and the scanner function. As a convenient and easy way, a method of erasing, by the CPU 111 on the SoC 110, the stored determination result whenever the software is rewritten may be used.

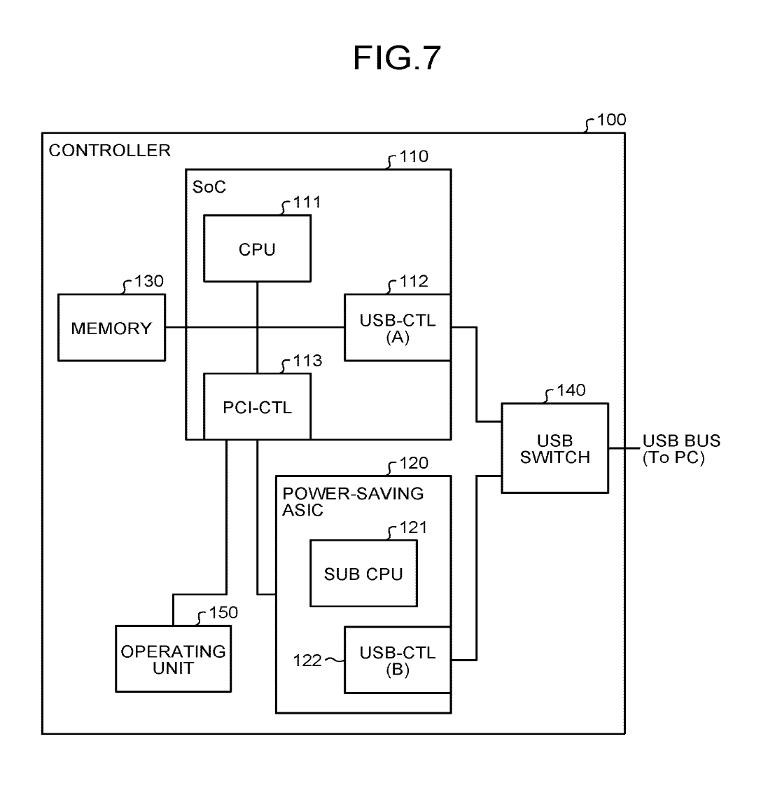

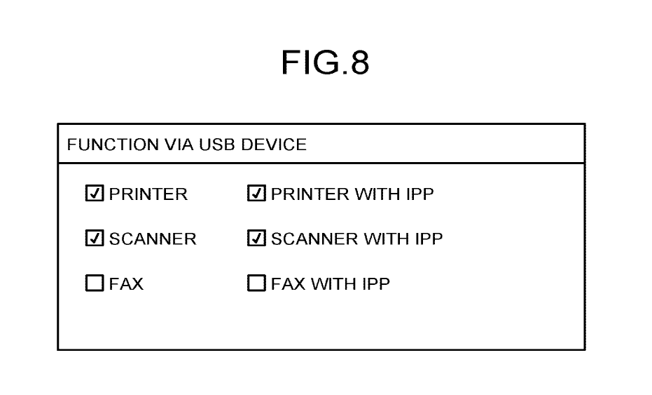

When the controller 100 includes an operating unit 150 as illustrated in FIG. 7 or when the equipment where the controller 100 is mounted includes the operating unit 150, the controller 100 may be configured to accept an input entered from the operating unit 150 and rewrite data stored in the nonvolatile storage device of the memory 130 depending on the input. FIG. 8 is a diagram illustrating an example operational screen on the operating unit 150. All the functions the controlled equipment has are displayed on this screen. When a check mark is put by a user in the box of a function the user desires to enable, the CPU 111 on the SoC 110 enables this function. This configuration allows, even when the controller 100 is mounted on the above-described printer supporting IPP over USB, a user to configure settings by himself/herself by operating the operating unit 150 so as not to use the IPP over USB protocol (in the example of FIG. 8, erasing the check marks put on the functions with IPP), thereby causing the USB device controller 122 that consumes less power to be selected.

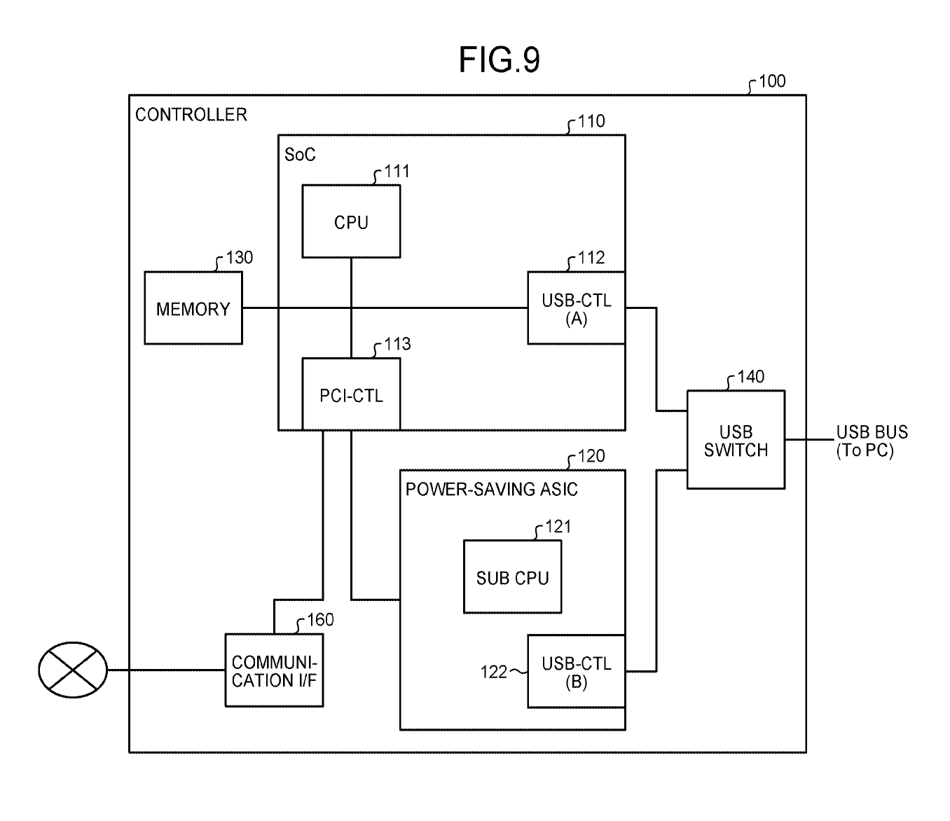

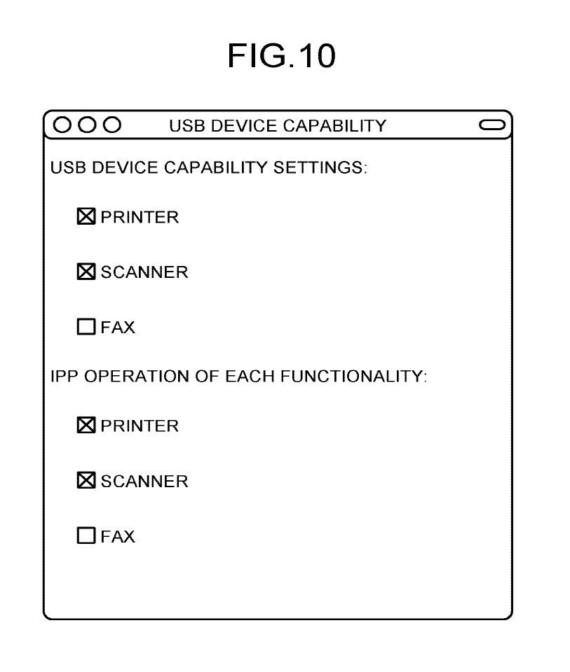

When the controller 100 is capable of network communication via a communication I/F (interface) 160 as illustrated in FIG. 9, the controller 100 may be configured to rewrite the data stored in the nonvolatile storage device according to data transmitted from an external apparatus through network communication. This example is similar to the above-described example that configures settings using the operating unit 150 except for that, in this example, network communication is used. This configuration allows configuring functional restriction and the like collectively from a remote site such that, for example, an IT administrator that is in a head office can manage and change settings of equipment installed in a branch office. When IPP over USB is disabled by this functional restriction, reduction in power consumption can also be achieved as described above. FIG. 10 illustrates an example operational screen for configuring settings via a Web UI (user interface).

The controller 100 may be configured to restart the equipment automatically if, when the data stored in the rewritable nonvolatile storage device is updated by an operation through the operating unit 150 or network communication, the update requires restart of the equipment. For example, a method for printing via USB using the printer function is not limited to a general printing method of installing dedicated driver software on a personal computer or the like and thereafter performing printing, but a printing method in compliance with an industry standard, such as the IPP, may be used. The same holds true for the scanner function and a FAX function. A change occurred to the data (a setting value) stored in the above-described rewritable nonvolatile storage device in response to that a part of these functions is enabled or disabled via the operating unit 150 or the Web as described above is a change that requires restart. However, when a change made to the settings is a change, such as changing setting of a network address, unrelated to USB communication, the controller 100 of the second embodiment eliminates the need of restart.

The control instructions for the controller 100 hold information about memory location where settings for the respective functions are stored in the rewritable nonvolatile storage device and can hold, as attributes of setting values of the respective functions, information as to whether or not restart is required to make a rewritten setting value effective.

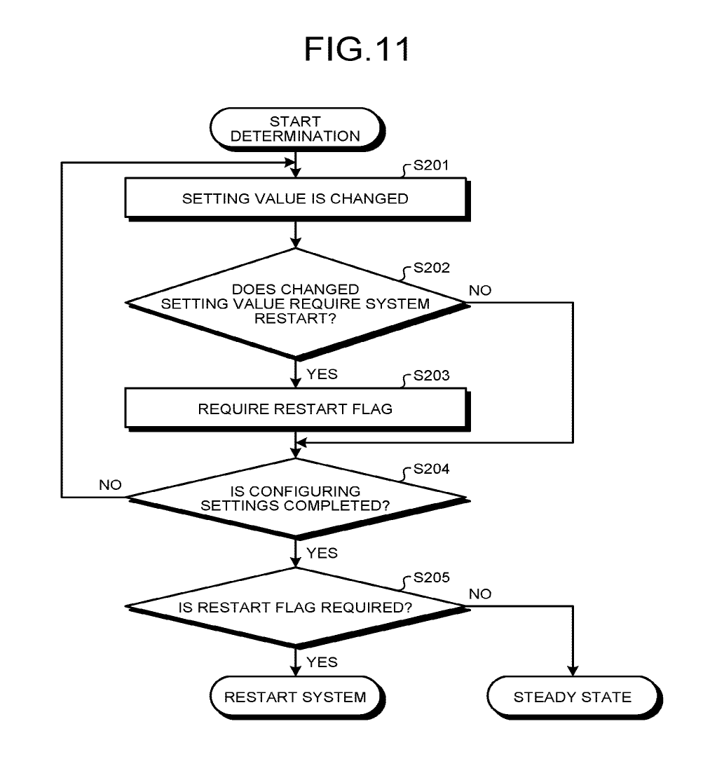

FIG. 11 is a flowchart of operations performed by the controller 100 of the second embodiment when data (a setting value) stored in a rewritable nonvolatile memory is changed.

As illustrated in FIG. 11, when an operation of changing the setting value is performed, the CPU 111 on the SoC 110 changes the setting value in the above-described rewritable nonvolatile storage device (step S201).

Thereafter, the CPU 111 determines whether or not restart is required based on the above-described attribute of the setting value. If restart is required (Yes at step S202), the CPU 111 sets a restart flag (step S203); otherwise, the CPU 111 causes processing to proceed to stepS204 to determine whether configuring settings is completed. If the operation of configuring settings is continuing (No at step S204), the CPU 111 causes processing to return to step S201.

On the other hand, if, when configuring settings is completed (Yes at step S204), the restart flag is not set (No at step S205), the CPU 111 maintains the ongoing operating state of the USB device controller 112 or 122 that is operating (i.e., selected) at that time. If the restart flag is set (Yes at step S205), the CPU 111 starts a restart sequence for restarting the equipment.

By virtue of automatically restarting the equipment when restart of the equipment is required in this manner, even if the controller 100 is configured to make a change made to the data stored in the rewritable nonvolatile storage device included in the memory 130 effective at start of the equipment, the change is made effective reliably. Furthermore, because power supply to the equipment is generally unmanipulatable by configuring settings from a remote site through network communication, the controller 100 desirably contains such a feature as described above.

The second embodiment allows, even when the equipment where the controller 100 is mounted is multi-functional, selecting a function(s) to be enabled as desired, thereby increasing user's convenience. Furthermore, the second embodiment can provide a necessary function(s) in a less-power-consuming state when it is known in advance that a certain function will not be used.

### Third Embodiment

There can be a situation where the control apparatus for shared used by a plurality of types of equipment is used by equipment, on which a USB connector, which is the communication connection terminal, is not mounted. For example, there may be a case where the control apparatus controls equipment, on which a USB connector itself is not mounted, such as a large printing apparatus. This case can occur with equipment where users generally do not require USB connection. However, there can be a case of providing, as an optional component, only the communication connection terminal to a user that desires to use USB connection even on such equipment and attaching the communication connection terminal to the control apparatus, thereby enabling USB printing. In such a case, if whether or not a USB connector is mounted is detectable, the communication connection terminal to be connected by the USB switch 140 can be selected appropriately. In a third embodiment, a component including a physical USB connector and connectable to a main body of the control apparatus is referred to as the “communication connection terminal”.

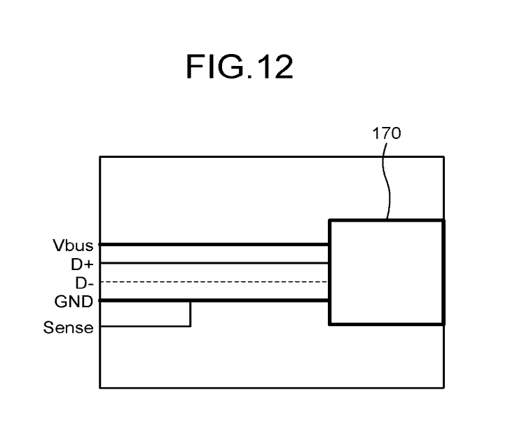

The third embodiment is configured such that a signal line group illustrated in FIG. 12 is coupled to at least one connection connector (communication end point) 170, which is for connection with the communication connection terminal, on the control apparatus main body to detect whether or not a physical USB connector is mounted. The connection connector 170 and the communication connection terminal are configured such that each of the signal lines is connected to the USB connector in accordance with the USB standard when the communication connection terminal is attached to the connection connector 170.

Vbus, D+, D−, and GND illustrated in FIG. 12 are signal lines of a signal line group necessary for the communication connection terminal compliant with the USB standard. Because Vbus connection is omitted in some cases, the Vbus signal line is optional. A Sense signal line is connected to GND on a circuit board that physically provides the communication connection terminal. On the SoC 110 side, a voltage is applied to the Sense signal line using a pull-up resistor. The CPU 111 on the SoC 110 can detect whether or not a physical USB connector is mounted by measuring a potential at the terminal of the Sense signal line.

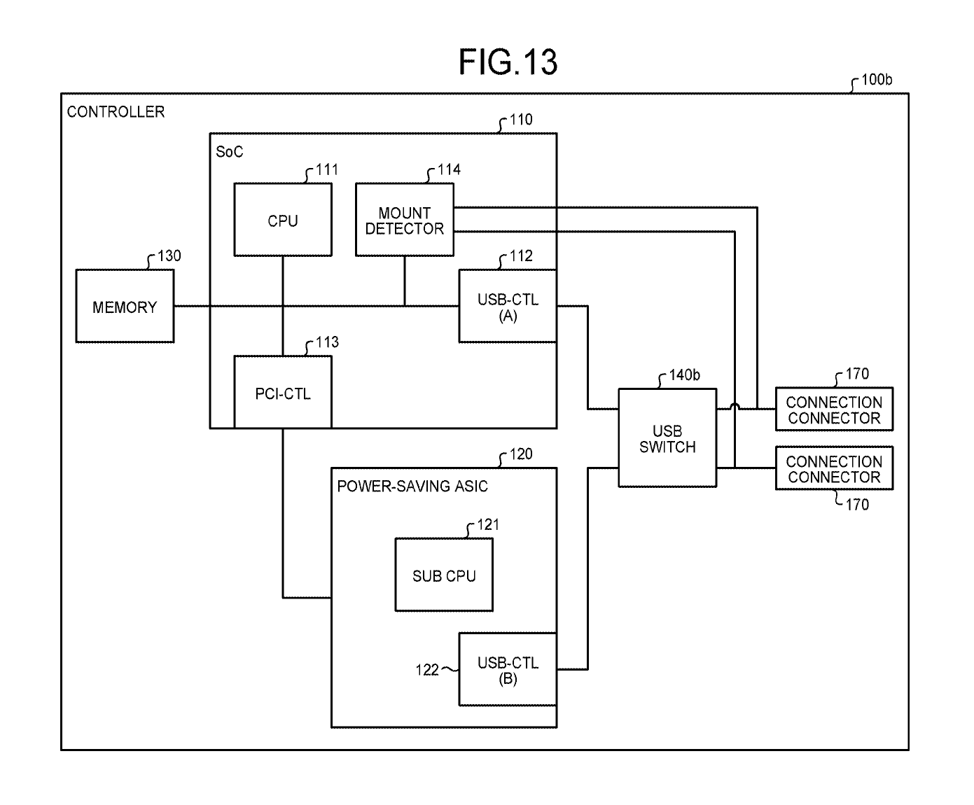

FIG. 13 is a block diagram illustrating a configuration of a control apparatus (controller) 100b of the third embodiment.

As illustrated in FIG. 13, in contrast to the controller 100 of the first embodiment described above, the controller 100b of the third embodiment includes a plurality of the connecting connectors 170, to which the communication connection terminals are respectively attachable. The connecting connectors 170 are connected to a USB switch (bus switch) 140b.

A mount detector 114 includes the above-described signal line group and pull-up resistors and is capable of detecting mount/unmount of the communication connection terminal(s) each including a physical USB connector in the above-described manner. The mount detector 114 can be implemented as an internal module of the SoC 110. In this case, the mount detector 114 is implemented as a GPIO (general-purpose input/output). The pull-up resistors may be implemented as a part of a function of the GPIO in some cases. When the GPIO does not have the function as the pull-up resistors, the pull-up resistors are to be externally mounted as independent components.

The USB switch (bus switch) 140b performs switching under control of the CPU 111 on the SoC 110 when one of the communication control devices is selected by the CPU 111 on the SoC 110 as described above in the first embodiment to connect a signal line coupled to the communication connection terminal where mount of a physical USB connector is detected by the mount detector 114 to the selected the communication control device 112 or 122.

The controller 100b of the third embodiment is similar to the controller 100 of the first embodiment in hardware structure except the above. The method for selecting one of the USB device controllers 112 and 122, which are the communication control devices, is basically similar to that of the first embodiment. However, the method of the third embodiment differs from that of the first embodiment in placing all the USB device controllers 112 and 122 in their minimum power consumption states when there is no communication connection terminal, on which a USB connector is mounted. A method of, when there is a plurality of communication connection terminals, on each of which a USB connector is mounted, connecting all the communication connection terminals to the USB device controllers 112 and 122 while imposing limitations on usages, may be employed.

According to an aspect of the present invention, when a control apparatus including communication control devices for communication with external equipment is applied to a plurality of types of equipment for shared use thereamong, wasteful power consumption by a circuit that is not used in communication with the external equipment can be advantageously reduced.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

What is claimed is:

1. A control apparatus mounted on equipment to control the equipment, the control apparatus comprising:
a plurality of communication control devices capable of communication with external equipment via a single communication connection terminal configured for communication with external equipment;
a switch configured to connect the communication connection terminal to any one of the plurality of communication control devices; and
a control unit configured to perform control operations including
selecting one, the one being suitable for a function enabled on the equipment where the control apparatus is mounted and minimizing power consumption, of the plurality of communication control devices,
causing the switch to connect the selected communication control device to the communication connection terminal, and
minimizing power consumption of the other, not-selected communication control device.

2. The control apparatus according to claim 1, wherein the enabled function is a function the equipment where the control apparatus is mounted has.

3. The control apparatus according to claim 1, further comprising a storage device, wherein the enabled function is one of functions the equipment has, the one being specified as an enabled function in data stored in the storage device.

4. The control apparatus according to claim 3, wherein the enabled function is specified by a user by updating the data stored in the storage device from an operating unit for use in operating the equipment where the control apparatus is mounted.

5. The control apparatus according to claim 3, wherein the enabled function is specified by updating the data stored in the storage device through network communication from an external apparatus operated by a user.

6. The control apparatus according to claim 4, wherein the control unit causes the equipment where the control apparatus is mounted to be automatically restarted if it is determined that the update of the data stored in the storage device requires restart of the equipment.

7. A control apparatus mounted on equipment to control the equipment, the control apparatus comprising:
a plurality of communication control devices capable of communication via any one of a plurality of communication connection terminals configured for communication with external equipment;
a switch configured to connect each of the plurality of communication connection terminals to any one of the plurality of communication control devices; and
a control unit configured to perform control operations including
selecting one, the one being suitable for a function enabled on the equipment where the control apparatus is mounted and minimizing power consumption, of the plurality of communication control devices,
causing the switch to connect the selected communication control device to the communication connection terminal, and
minimizing power consumption of the other, not-selected communication control device.

8. The control apparatus according to claim 7, wherein the enabled function is a function the equipment where the control apparatus is mounted has.

9. The control apparatus according to claim 7, further comprising a storage device, wherein the enabled function is one of functions the equipment has, the one being specified as an enabled function in data stored in the storage device.

10. The control apparatus according to claim 9, wherein the enabled function is specified by a user by updating the data stored in the storage device from an operating unit for use in operating the equipment where the control apparatus is mounted.

11. The control apparatus according to claim 9, wherein the enabled function is specified by updating the data stored in the storage device through network communication from an external apparatus operated by a user.

12. The control apparatus according to claim 10, wherein the control unit causes the equipment where the control apparatus is mounted to be automatically restarted if it is determined that the update of the data stored in the storage device requires restart of the equipment.

13. The control apparatus according to claim 2, further comprising:
at least one communication end point, to which the communication connection terminal is attachable; and
a mount detector configured to detect whether or not the communication connection terminal is mounted on the communication end point, wherein
the control unit performs control operations including
selecting one, the one being suitable for the function enabled on the equipment where the control apparatus is mounted and minimizing power consumption, of the plurality of communication control devices,
causing the switch to connect the selected communication control device to the communication connection terminal where the mount is detected by the mount detector, and
minimizing power consumption of the other, not-selected communication control device.

14. A control method for a control apparatus mounted on equipment to control the equipment, the control method comprising the following control operations performed by a control unit included in the control apparatus:
selecting one, the one being suitable for a function enabled on the equipment where the control apparatus is mounted and minimizing power consumption, of a plurality of communication control devices capable of communication with external equipment via a single communication connection terminal configured for communication with external equipment;
causing a switch, the switch being configured to connect the communication connection terminal to any one of the plurality of communication control devices, to connect the selected communication control device to the communication connection terminal; and
minimizing power consumption of the other, not-selected communication control device.
